(19) United States
(12) Patent Application Publication
(10) Pub. No.: US 2018/0282468 A1
(43) Pub. Date: Oct. 4, 2018

(54) HALOGEN FREE FLAME RETARDANT WATERBORNE COATING COMPOSITION FOR TEXTILE

(71) Applicant: DSM IP Assets B.V., Heerlen (NL)

(72) Inventors: John REISCH, Echt (NL); Richard KIRTON, Echt (NL); Anne HANDY, Echt (NL); Mindelle BALKUN, Echt (NL); Robert PUYENBROEK, Echt (NL)

(21) Appl. No.: 15/763,279

(22) PCT Filed: Sep. 28, 2016
(86) PCT No.: PCT/EP2016/073124

§ 371 Date: Mar. 26, 2018

Related U.S. Application Data
(60) Provisional application No. 62/235,765, filed on Oct. 1, 2015.

(30) Foreign Application Priority Data
Oct. 23, 2015 (EP) EP15191263.1

(51) Int. Cl. C08G 18/38; C09D 175/04; C08G 18/10; C08G 18/42; C09D 5/18; C08G 18/66; C08G 18/70; C08G 18/75; C08G 18/08; D06M 15/564

(52) U.S. Cl. CPC C08G 18/388; C09D 175/04; C08G 18/10; C08G 18/4238; C09D 5/18; D06M 2101/32; C08G 18/706; C08G 18/758; C08G 18/0823; C08G 18/4241; D06M 15/564; C08G 18/6637

(57) ABSTRACT

The present invention relates to a flame retardant waterborne coating composition comprising: a) water dispersed hydroxyl-terminated polyurethane particles, and b) isocyanate crosslinker, wherein (i) the hydroxyl-terminated polyurethane contains phosponate oligomer as a building block in an amount of from 3 to 75 parts by weight relative to the hydroxyl-terminated polyurethane, wherein the phosphonate oligomer contains units according to the following structural formula in which n is an integer from 1 to 20, R is a C₁₋₂₀ alkyl, C₂₋₂₀ alkene, C₂₋₂₀ alkyne, C₅₋₂₀ cycloalkyl or C₆₋₂₀ aryl, and R₂ is an aliphatic or aromatic group, (ii) the hydroxyl number of the hydroxyl-terminated polyurethane is from 5 to 180 mg KOH/g polyurethane, (iii) the molar ratio of hydroxyl groups present in the hydroxyl-terminated polyurethane to isocyanate groups of the crosslinker is from 0.2 to 2.0.

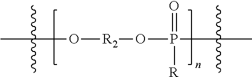

The present invention relates to a flame retardant waterborne polyurethane coating composition, and more particularly, for use on textiles. In particular this invention relates to flame retardant polyurethane coating compositions containing a halogen free flame retardant, a method for the preparation thereof and the use of said halogen free coating compositions to coat textile fabrics.

Polyurethane (PU) coatings are applied to textiles to provide hydrostatic resistance, durability, breathability and/or flame retardancy. Historically solvent-based PU coatings have been mainly used. However, because solvent-based PUs may emit toxics, waterborne PUs have been developed. Solvents are volatile organic compounds and contribute to air pollution. Water borne coatings are inherently safer for the environment. This invention aims at developing an eco-friendly flame retardant textile fabric using a non-halogenated flame retardant. The current invention provides an aqueous halogen-free, effective fire retardant finish to various textile fabric substrates.

Textiles are an essential part of everyday life and are found, for example, in draperies, clothing, furniture and vehicle upholsteries, toys, packaging material and many more applications. Consequently, textile flammability is of concern.

Heretofore, it has been widely practiced to apply polyurethane coatings to various textiles, such as polyamide and polyester fabrics. However, those coated fabrics are extremely flammable and therefore, it is necessary to make them flame retardant. Many attempts have been made to obtain flame retardant polyurethane coating compositions, since also polyurethane has poor flame-retarding properties and thus are also easily ignited. As such, flame retardant waterborne polyurethane coating compositions are known. Brominated and chlorinated flame retardant additives are widely used to provide flame retardancy to the coating. Antimony oxide is also commonly used as a synergist with other flame retardant additives. Environmental and health concerns have caused halogenated flame retardant coatings to be undesirable and they are being increasingly regulated. For example, the U.S. Environmental Protection Agency (EPA) recently banned decabromodiphenyl oxide, a commonly used brominated flame retardant additive. Products containing chlorine, bromine or heavy metals need special care when being disposed of at the end of their useful life.

The principal object of the invention is to provide a halogen-free flame retardant waterborne polyurethane coating composition superior in flame resistance, in particular when applied on textiles. A further object of the invention is to provide an improved flame retardant coated fabric.

It has surprisingly been found that this object can be achieved by a flame retardant waterborne coating composition comprising:
a) water dispersed hydroxyl-terminated polyurethane particles, and
b) isocyanate crosslinker,
wherein
(i) the hydroxyl-terminated polyurethane contains phosponate oligomer as a building block in an amount of from 3 to 75 parts by weight relative to the hydroxyl-terminated polyurethane, wherein the phosphonate oligomer contains units according to the following structural formula

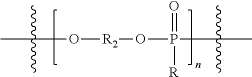

in which n is an integer from 1 to 20, R is a C₁₋₂₀ alkyl, C₂₋₂₀ alkene, 02-20 alkyne, C₅₋₂₀ cycloalkyl or C₆₋₂₀ aryl, and R₂ is an aliphatic or aromatic group,
(ii) the hydroxyl number of the hydroxyl-terminated polyurethane is from 5 to 180 mg KOH/g polyurethane,
(iii) the molar ratio of hydroxyl groups present in the hydroxyl-terminated polyurethane to isocyanate groups of the crosslinker is from 0.2 to 2.0.

It has surprisingly been found that a textile can be rendered superior in flame resistance when coated with the coating composition according to the invention. It has further surprisingly been found that in the present invention the flame retardant is not leached out when the coated fabric is soaked in water and the flame retardant is also not washed out when the coated fabric is washed in water.

The flame retardant polyurethane coating of the present invention is derived from the reaction of at least a phosphonate diol containing units according to the formula as given above and an isocyanate, which results in incorporating of the flame retardant species into the backbone of the polymer.

US-A-20100152374 discloses flame-retardant waterborne polyurethane dispersions whereby a polyphosphate ester is incorporated into the polyurethane backbone. A phosphate ester like that disclosed in US-A-20100152374 (Exolit OP550) was tried in comparative experiment B and the flame retardant performance was inferior to the phosphonate diols of the present invention.

The phosphonate diols used in the present invention are commercially available from FRX Polymers, Inc. and their compositions and preparation are described in U.S. Pat. No. 8,530,044, U.S. Pat. No. 8,563,638, and U.S. Pat. No. 8,779,041 and US 2014/0000751.

The phosphonate oligomer building block contains units according to the following structural formula

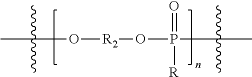

In which n, R and R₂ are as stated above. Preferably R₂ is an aromatic group and more preferably —O—R₂—O— is derived from resorcinol, hydroquinone or bisphenol. Most preferably —O—R₂—O— is derived from bisphenol-A. Preferably n is an integer from 1 to 10. Preferably R is a methyl group.

The phosphonate oligomer used in the preparation of the hydroxyl terminated polyurethane is a phosphonate diol and is preferably selected from the group consisting of a random co-oligo(phosphonate carbonate), a block co-oligo(phosphonate carbonate), a random co-oligo(phosphonate ester), a block co-oligo(phosphonate ester) or any mixture thereof.

More preferably, the phosphonate oligomer building block has a structure according to one of the following formulae:

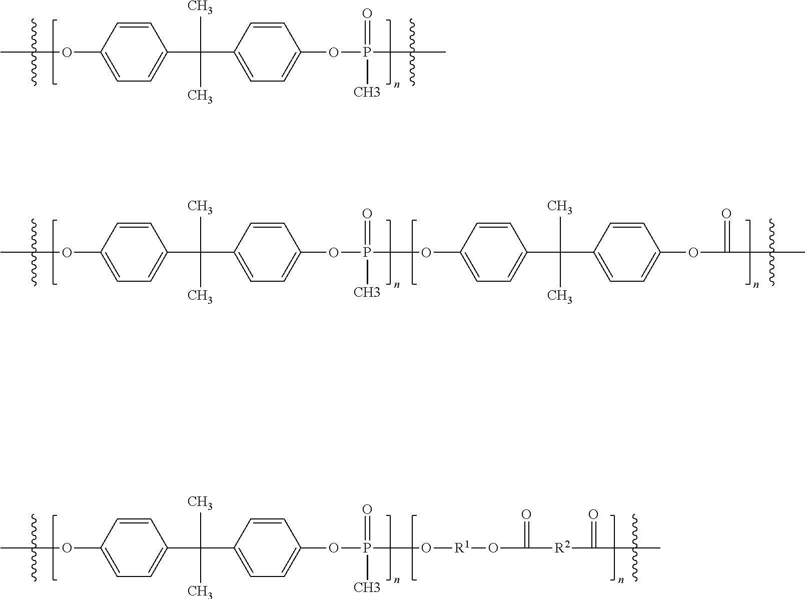

in which R¹ and R² are aliphatic or aromatic hydrocarbons, and n is an integer from 1 to 20, preferably from 1 to 10.

Even more preferably, the phosphonate oligomer used in the preparation of the hydroxyl terminated polyurethane is a copolymer of bisphenol-A and diphenyl methyl phosphonate. Such compounds may have structures such as, but not limited to, the three structures illustrated hydroxyl number above.

Preferably, the hydroxyl number of the phosphonate oligomer used in the preparation of the hydroxyl terminated polyurethane is from 10 to 200 mg KOH/g phosphonate oligomer, more preferably from 20 to 200 mg KOH/g phosphonate oligomer and even more preferably from 40 to 120 mg KOH/g phosphonate oligomer. As used herein, the hydroxyl number of the phosphonate oligomer is determined according to ASTM D4272-11.

Preferably, the OH equivalent weight of the phosphonate oligomer used in the preparation of the hydroxyl terminated polyurethane is from 280 to 5610, more preferably from 280 to 2805, even more preferably from 450 to 1400. The OH equivalent weight is determined by dividing 56100 by the OH number.

The hydroxyl number of the hydroxyl-terminated polyurethane is from 5 to 180 mg KOH/g polyurethane, preferably from 10 to 130 mg KOH/g polyurethane and more preferably from 10 to 50 mg KOH/g polyurethane. As used herein, the hydroxyl number of the hydroxyl-terminated polyurethane is determined according to ASTM D4274-11.

The isocyanate crosslinker used in the present invention is a water-dispersible polyisocyanate. Any known water-dispersible polyisocyanate may be used, but preferably a water-dispersible aliphatic or cycloaliphatic polyisocyanate is used, more preferably a water-dispersible aliphatic or cycloaliphatic di- or trifunctional polyisocyanate preferably manufactured from isophorone diisocyanate (IPDI), hexamethylene diisocyanate (HDI), or 4,4′-methylene-dicyclohexyl diisocyanate (H₁₂MDI) or a blend of at least two of these diisocyanates.

In the present invention, the amount of isocyanate crosslinker is preferably from 0.5 to 20% based on the weight of the OH functional polyurethane dispersion, more preferably from 2 to 10% based on the weight of the hydroxyl-terminated polyurethane.

In one embodiment of the present invention, the flame retardant waterborne coating composition is a one-component (1K) system. In this embodiment the isocyanate crosslinker is a blocked polyisocyanate.

In the present invention, the flame retardant waterborne coating composition is preferably obtained by mixing just before application a multi package system comprising at least two packages. One package comprises the water-dispersed polyurethane as described above and the other package comprises the isocyanate. Preferably, a two package system (a two-component (2K) system) is applied. Non-limited examples of second package isocyanate crosslinkers are Bayhydur® 302, Bayhydur® 303, Bayhydur® 304, Bayhydur® VPLS 2306 all of which are available from Bayer Material Science now known as Covestro.

Many different second package isocyanate crosslinkers may be used including those derived from hexamethylene diisocyanate (HDI) trimer, HDI biuret, HDI allophanate, isophorone diisocyanate trimer, adducts of isocyanate with trimethylol propane, and isocyanate adducts that have been hydrophically modified to make them compatible with water. Examples of isocyanate crosslinkers that may be used include but are not limited to the following: Desmodur N3300, Desmodur N3400, Desmodur N100, Desmodur N3200 all of which are available from Bayer Material Science now known as Covestro, and Tolonate HDT-LV, Tolonate HDT, Tolonate HDB, which are all available from Vencorex. Examples of hydrophically modified isocyanate crosslinkers that may be used include but are not limited to: Bayhydur 302, Bayhydur 303, Bayhydur 304, Bayhydur VPLS 2306 all of which are available from Bayer Material Science now known as Covestro, and Easaqua XL 600, Easaqua SC 803, Easaqua XB 401, Easaqua M 502, Easaqua M 501, Easaqua Wat-4, and Easaqua WAT-3 all of which are available from Vencorex.

The amount of hydroxyl-terminated polyurethane in the flame-retardant waterborne coating composition according to the invention is from 10 to 99 wt. %, preferably from 20 to 97 wt. % and more preferably from 25 to 75 wt. % (relative to the total coating composition).

The molar ratio of hydroxyl groups present in the hydroxyl-terminated polyurethane to isocyanate groups of the crosslinker is from 0.2 to 2.0, preferably from 0.2 to 1.0.

Preferably, the coating composition of the present invention is bromine free, preferably halogen free.

The hydroxyl-terminated polyurethane is preferably obtained by reacting
(a) from 5 to 50 parts by weight of at least one polyisocyanate,
(b) from 3 to 75 parts by weight of at least one phosphonate diol oligomer as described above,
(c) from 0.5 to 30 parts by weight of at least one isocyanate-reactive polyol containing non-ionic, ionic and/or potentially ionic water dispersing groups,
(d) from 0 to 75 parts by weight of at least one isocyanate-reactive polyol not comprised by (b) or (c),
to obtain an isocyanate-terminated polyurethane prepolymer, and reacting the isocyanate-terminated polyurethane prepolymer with
(e) from 0 to 20 parts by weight of neutralizing agent, and
(f) from 1 to 20 parts by weight of at least one active hydrogen-containing chain-extending compound, which is capable of forming hydroxyl groups, whereby the amounts of (a), (b), (c) and (d) are given relative to the total amount of components used to prepare the isocyanate-terminated polyurethane prepolymer from which the building blocks of the isocyanate-terminated polyurethane prepolymer are emanated, and whereby the amounts of (e) and (f) is given relative to the weight amount of the isocyanate-terminated polyurethane prepolymer.

Methods for preparing polyurethanes are known in the art and are described in for example the Polyurethane Handbook 2^{nd} Edition, a Carl Hanser publication, 1994, by G. Oertel.

### Component (a)

Component (a) is at least one polyisocyanate, preferably at least one organic difunctional isocyanate. The amount of component (a) relative to the total amount of components used to prepare the isocyanate-terminated polyurethane prepolymer from which the building blocks of the isocyanate-terminated polyurethane prepolymer are emanated is preferably from 5 to 50 wt. % and more preferably from 10 to 35 wt. %.

Preferably, the polyisocyanate is selected from the group consisting of toluene diisocyanate (TDI), p-phenylene diisocyanate (PPDI), 4,4′-diphenylmethane diisocyanate (MDI), p,p′-bisphenyl diisocyanate (BPDI), isophorone diisocyanate (IPDI), 1,6-hexamethylene diisocynate (HDI), hydrogenated diphenylmethane-4,4′-diisocyanate (H₁₂MDI), meta-tetramethylxylene diisocyanate (TMXDI), trimethylhexamethylene diisocyanate (TMHDI) and any mixture thereof.

### Component (b)

Component (b) is at least one phosphonate diol oligomer as described above. The amount of component (b) relative to the total amount of components used to prepare the isocyanate-terminated polyurethane prepolymer from which the building blocks of the isocyanate-terminated polyurethane prepolymer are emanated is preferably from 3 to 75 wt. % and more preferably from 5 to 20 wt. %.

### Component (c)

Component (c) is at least one isocyanate-reactive polyol containing non-ionic, ionic and/or potentially ionic water dispersing groups. The amount of component (c) relative to the total amount of components used to prepare the isocyanate-terminated polyurethane prepolymer from which the building blocks of the isocyanate-terminated polyurethane prepolymer are emanated is from 0.5 to 30 wt. % and preferably from 6 to 21 wt. %. Potentially ionic water-dispersing groups include groups which are subsequently (upon neutralization) converted to water-dispersing groups. For example free (unionised) carboxylic acid groups can be neutralised to carboxylate anionic water-dispersing groups.

Component (c) preferably comprises
(c.1) from 0.5 to 10 wt. %, preferably from 1 to 6 wt. % of an isocyanate-reactive polyol containing ionic and/or potentially ionic water-dispersing groups having a molecular weight of from 100 to 500 g/mol,
(c.2) from 0 to 20 wt. %, preferably from 5 to 15 wt. % of at least one isocyanate-reactive polyol containing non-ionic water-dispersing groups, where the amounts of (c.1) and (c.2) are given relative to the total amount of components used to prepare the isocyanate-terminate polyurethane prepolymer from which the building blocks of the isocyanate-terminate polyurethane prepolymer are emanated.

Component (c.1) is at least one isocyanate-reactive polyol (preferably diol) containing ionic or potentially ionic water-dispersing groups and having a molecular weight of from 100 to 500 g/mol.

Preferred anionic water-dispersing groups are carboxylic, phosphoric and/or sulphonic acid groups. Examples of such compounds include carboxyl containing diols, for example dihydroxy alkanoic acids such as 2,2-dimethylol propionic acid (DMPA) or 2,2-dimethylolbutanoic acid (DMBA). Alternatively sulfonate groups may be used as potentially anionic water-dispersing groups. The anionic water-dispersing groups are preferably fully or partially in the form of a salt. Conversion to the salt form is optionally effected by neutralisation of the polyurethane prepolymer with a base, preferably during the preparation of the polyurethane prepolymer and/or during the preparation of the aqueous composition of the present invention. If the anionic water-dispersing groups are neutralised, the base used to neutralise the groups is preferably ammonia, an amine or an inorganic base. Suitable amines include tertiary amines, for example triethylamine or N,N-dimethylethanolamine. Suitable inorganic bases include alkali hydroxides and carbonates, for example lithium hydroxide, sodium hydroxide, or potassium hydroxide. A quaternary ammonium hydroxide, for example N⁺(CH₃)₄(OH), can also be used. Generally a base is used which gives counter ions that may be desired for the composition. For example, preferred counter ions include Li⁺, Na⁺, K⁺, NH₄⁺ and substituted ammonium salts. Cationic water dispersible groups can also be used, but are less preferred. Examples include pyridine groups, imidazole groups and/or quaternary ammonium groups which may be neutralised or permanently ionised (for example with dimethylsulphate). A very suitable component (c.1.) is dimethylol propionic acid (DMPA) and/or dimethylol butanoic acid (DMBA).

The neutralising agent is preferably used in such an amount that the molar ratio of the ionic and potentially ionic water dispersing groups to the neutralizing groups of the neutralising agent are in the range of from 0.7 to 5.0, more preferably from 0.8 to 3.0 and even more preferably from 0.85 to 1.2.

Component (c.2) is at least one isocyanate-reactive polyol (preferably diol) containing non-ionic water-dispersing groups. Non-ionic dispersing groups are typically pendant polyoxyalkylene groups, particularly polyethylene oxide (PEO) groups. Such groups may, for example be provided by employing as a reactant in the prepolymer formation diols having pendant PEO chains such as those described in the prior art, for example U.S. Pat. No. 3,905,929. Chain-pendant PEO groups may also be introduced by employing certain amine and hydroxyl functional compounds, or diols, as disclosed in EP 0317258. If desired, the PEO chains may contain units of other alkylene oxides in addition to the ethylene oxide units. Thus, PEO chains in which up to 60% of the alkylene oxide units are propylene oxide units, the remainder being ethylene oxide units, may be used.

### Component (d)

Component (d) is at least one isocyanate-reactive polyol not comprised by (b) or (c). The amount of component (d) relative to the total amount of components used to prepare the isocyanate-terminated polyurethane prepolymer from which the building blocks of the isocyanate-terminated polyurethane prepolymer are emanated is preferably from 0 to 60 wt. % and more preferably from 10 to 50 wt. %. Such polyol may be selected from any of the chemical classes of polyols that can be used in polyurethane synthesis. In particular the polyol may be a polyester polyol, a polyesteramide polyol, a polyether polyol, a polythioether polyol, a polycarbonate polyol, a polyacetal polyol, a polyvinyl polyol and/or a polysiloxane polyol. The polyol (d) preferably comprises a polyester polyol, a polyether polyol and/or a polycarbonate polyol; more preferably the polyol (d) is a polyester polyol, even more preferably made from ethylene glycol and adipic acid and/or made from diethylene glycol and adipic acid.

### Component (f)

Component (f) is at least one active hydrogen-containing chain-extending compound, which is capable of forming hydroxyl groups

The amount of component (f) relative to the weight amount of the isocyanate-terminated polyurethane prepolymer from which the building blocks of the isocyanate-terminated polyurethane prepolymer are emanated is from 1 to 20 wt. % and more preferably from 2 to 10 wt. %.
Component (f) is at least one active-hydrogen chain extending compound with a functionality of at least 2.

The aqueous composition may be prepared by dispersing an isocyanate-terminated polyurethane prepolymer in an aqueous medium and chain extending the prepolymer with at least one active hydrogen-containing chain extending compound with a functionality of at least 2 in the aqueous phase. Active hydrogen-containing chain extenders (component (f)) which may be reacted with an isocyanate-terminated polyurethane prepolymer preferably include diamines or polyamines containing OH functionality, preferably diamines containing OH functionality are used.

Preferably the active-hydrogen chain extending compound is selected from the group consisting of amino-alcohols, such as N-(2-hydroxyethyl)ethylene diamine.

The chain extender may be added to the aqueous dispersion of the isocyanate-terminated polyurethane prepolymer or, alternatively, it may already be present in the aqueous medium when the isocyanate-terminated polyurethane prepolymer is dispersed therein. The chain extension may be conducted at convenient temperatures from about 5° C. to 95° C. or, more preferably, from about 10° C. to 60° C.

The flame retardant waterborne coating composition according to the present invention may further comprise additives such as for example rheology additives.

The present invention further relates to the use of the flame retardant waterborne coating composition as described above to coat textile fabrics. The present invention also further relates to a coated fabric which is obtained by applying to a textile a coating composition as described above. Preferably, the textile contains fibers, preferably polyester fibres, polypropylene fibres, and/or polyamide fibres.

The present invention is also directed to an article comprising the coated fabric as described herein. The article is preferably selected from the group consisting of furniture, a drapery, a garment, linen, a mattress, a carpet, a tent, a sleeping bag, a toy, a decorative fabric, an upholstery, a wall fabric, a curtain, a canopy, clothing apparel, vehicle upholstery, an awning, an airline seat, an airbag cover and combinations thereof.

The present invention is now illustrated by reference to the following example. Unless otherwise specified, all parts, percentages and ratios are on a weight basis.

### Materials Used

Nofia® OL 1001 obtained from FRX Polymer
Nofia® OL 3001 obtained from FRX Polymer
Bayhydur® 302, an isocyanate crosslinker, obtained from Bayer.
Exolit® OP 550 obtained from Clariant
Fyrol® 6 obtained from Supresta
Desmodur® W, an aliphatic diisocyanate obtained from Bayer
Bayhydur 302 an aliphatic isocyanate crosslinker obtained from Bayer
K-Stay 730 thickener was obtained from King Industries

### EXAMPLES AND COMPARATIVE EXPERIMENTS

### Example 1

### Synthesis of an OH Functional Water Borne Polyurethane Dispersion Containing Nofia® OL 1001 Phosphonate Diol.

The following were charged to a resin kettle and capped with nitrogen: Polyester polyol composed of adipic acid, diethylene glycol, and trimethyol propane, (353.96 g, 1150 eq.wt., 0.3078 eq.), Nofia® OL 1001 (25.53 g, 710.1 eq.wt., 0.0360 eq.), dimethylol propionic acid (12.99 g, 67.07 eq.wt., 0.1937 eq.), dicyclohexylmethane-4,4′-diisocyanate (109.44 g, 131.1 eq.wt., 0.8348 eq.), bismuth neodeconate catalyst (0.15 g), methylethylketone (142.88 g). The mixture was heated to 78 C for 3 hours. The free NCO value was determined by dibutyl amine titration and found to be 1.98% (theory 1.93%). Triethylamine (10.19 g 101.19 eq.wt., 0.1085 eq.) was added and the mixture was stirred for 10 minutes. Water (786.8 g) was added with rapid mixing to form a water borne polyurethane dispersion. A mixture of N(2-hydroxyethyl)ethylenediamine (13.84 g, 52.075 amine eq.wt., 0.2658 eq.) was mixed with water (30 g) and added to the dispersion slowly. The mixture was stirred for 1 hour then it was vacuum stripped to remove the methylethylketone. A solvent free water borne polyurethane dispersion was produced containing 40% solids. The hydroxyl number of the polyurethane was 14.4.

142.5 g of this water borne polyurethane dispersion was compounded with Bayhydur 302 (7.5 g) and K-Stay 730 associative thickener (1.6 g) to give a coating with a viscosity of 60,000 cps. The molar ratio of hydroxyl groups present in the hydroxyl-terminated polyurethane to isocyanate groups of the crosslinker was 0.47. The compounded coating was coated on 200 denier nylon oxford fabric with a knife over roll coater and then heat cured for 90 seconds at 163 degrees C. The coating wt. on fabric is 40.7 g per m² (1.2 ounce per square yard).

The fabrics coated with these water borne polyurethane flame retardant coatings were tested with vertical flame retardant tests CPAI-84 “A Specification for Flame-Resistant Materials Used in Camping Tentage” and NFPA 701 “Fire Tests for Flame-Resistant Textiles and Films”.

To pass the CPAI-84 test the maximum individual char length is 25.5 cm (10.04 inches) and the maximum average char length is 21.6 cm (8.5 inches). The maximum individual after flame is 4 seconds with a maximum average of 2 seconds.

To pass the NFPA 701 test the max individual char length is 16.8 cm (6.60 inches) and the maximum average is 14 cm (5.50 inches). The maximum individual after flame is 2 seconds.

The results are given below.

| | | Individual char | Individual |
|---|---|---|---|
| Example 1 | | length in cm | after flame |
| (before leaching) | | (inches) | (seconds) |
| | Warp | 8.4 (3.3) | 0.0 |
| | Warp | 8.4 (3.3) | 0.0 |
| | Warp | 8.9 (3.5) | 0.0 |
| | Fill | 8.9 (3.5) | 0.0 |
| | Fill | 9.4 (3.7) | 0.0 |
| | Fill | 9.7 (3.8) | 0.0 |
| Average | | 8.9 (3.5) | 0.0 |

The coated fabric of Example 1 with the Nofia® OL 1001 in the PU backbone passed the Vertical FR CPAI-84 and NFPA 701 tests with an average char length of 8.9 cm (3.5 inches) and no after flames.
The coated fabric of Example 1 was leached in water for 72 hours and the water was changed every 24 hours. The leached fabric was retested in the flame retardant tests: The results are given below.

| Example 1 | | Individual char | Individual |
|---|---|---|---|
| (after 72 hours | | length in cm | after flame |
| leaching in water) | | (inches) | (seconds) |
| | Warp | 9.4 (3.7) | 0.0 |
| | Warp | 9.4 (3.7) | 0.0 |
| | Warp | 8.6 (3.4) | 0.0 |
| | Fill | 9.4 (3.7) | 0.0 |
| | Fill | 9.1 (3.6) | 0.0 |
| | Fill | 9.4 (3.7) | 0.0 |
| Average | | 9.1 (3.6) | 0.0 |

The flame retardant results after leaching were excellent with an average char length of 9.1 cm (3.6 inches) and no after flames, thus both the CPAI-84 and NFPA 701 tests were passed.
Thus the flame retardant Nofia® OL 1001 is not leached out of the coating.

### Comparative Experiment A

An identical water borne polyurethane dispersion to that described for Example 1 was produced except that the Nofia® OL1001 was left out. The hydroxyl number of the polyurethane was 14.5.

The water borne polyurethane dispersion for Comparative Experiment A was compounded in the same way as in Example 1 and also coated on 200 denier nylon fabric. The molar ratio of hydroxyl groups present in the hydroxyl-terminated polyurethane to isocyanate groups of the crosslinker was 0.47. The coating wt. on fabric is 40.7 g per m² (1.2 ounce per square yard).

The cured coated fabrics were tested for flame retardant properties using the Vertical FR CPAI-84 test and the NFPA 701 test. The results are given below.

| | | Individual char | Individual |
|---|---|---|---|
| | | length in cm | after flame |
| Comp Ex A | | (inches) | (seconds) |
| | Warp | 8.9 (3.5) | 0.0 |
| | Warp | 8.4 (3.3) | 0.0 |
| | Warp | 8.6 (3.4) | 0.0 |
| | Fill | 10.2 (4.0) | 3.0 |
| | Fill | 8.9 (3.5) | 0.0 |
| | Fill | 10.2 (4.0) | 15.0 |
| Average | | 9.1 (3.6) | 3.0 |

Example 1 with the Nofia® OL 1001 in the PU backbone passed the Vertical FR CPAI-84 and NFPA 701 tests with an average char length of 8.9 cm (3.5 inches) and no after flames. Comparative A, without the phosphonate diol in the backbone of the polymer, failed the Vertical FR CPAI-84 test because the average after flame was 3 seconds and an individual value was 15 seconds. It also failed the NFPA 701 test because 2 of the individual after flame values were above 2 seconds.

The coated fabric of Comparative Experiment A was not submitted to leaching since the coated fabric of Comparative Experiment A did not even pass the CPAI-84 and NFPA-701 flame retardant tests before the coated fabric was leached in water.

### Example 2

An OH functional water borne polyurethane dispersion containing Nofia® OL 3001 phosphonate diol was synthesized with the same composition as for example 1 except that Nofia® OL 3001 was used in place of Nofia® OL 1001. The Nofia® OL 3001 is a copolymer made from bisphenol-A and diphenyl methyl phosphonate. The Nofia® OL3001 has an OH number of 50 and an OH equivalent weight of 1122. This OH functional (hydroxyl number of the polyurethane 14.2) water borne polyurethane dispersion containing Nofia® OL 3001 phosphonate diol was compounded with Bayhydur 302, and thickened to 60,000 cps with K-Stay 730 associative thickener. The molar ratio of hydroxyl groups present in the hydroxyl-terminated polyurethane to isocyanate groups of the crosslinker was 0.47. The compounded coating was coated on 200 denier nylon oxford fabric with a knife over roll coater and then heat cured for 90 seconds at 163 degrees C. The coating wt. on fabric is 40.7 g per m² (1.2 ounce per square yard) and for the coated fabric tested after 72 hours leaching in water 37.3 g per m² (1.1 ounce per square yard).

The cured coated fabric was tested for flame retardant properties using the Vertical FR CPAI-84 test and the NFPA 701 test.

| | Individual char | Individual |
|---|---|---|
| | length in cm | after flame |
| | (inches) | (seconds) |
| Example 2 | | |
| (before leaching) | | |
| Warp | 9.9 (3.9) | 0.0 |
| Warp | 8.6 (3.4) | 0.0 |
| Warp | 8.9 (3.5) | 0.0 |
| Fill | 10.2 (4.0) | 0.0 |
| Fill | 9.1 (3.6) | 0.0 |
| Fill | 10.2 (4.0) | 0.0 |
| Average | 9.4 (3.7) | 0.0 |
| Example 2 | | |
| (after 72 hours | | |
| leacing in water) | | |
| Warp | 9.7 (3.8) | 0.0 |
| Warp | 8.6 (3.4) | 0.0 |
| Warp | 7.4 (2.9) | 0.0 |
| Fill | 8.9 (3.5) | 0.0 |
| Fill | 7.6 (3.0) | 0.0 |
| Fill | 9.9 (3.9) | 0.0 |
| Average | 8.6 (3.4) | 0.0 |

The flame retardant results were excellent with average char lengths of 9.4 cm (3.7 inches) before leaching and 8.6 cm (3.4 inches) after leaching and zero after flames in both cases. These results passed both the CPAI-84 and NFPA 701 tests. Thus the flame retardant Nofia® OL 3001 is not leached out of the coating.

### Example 3

An OH functional water borne polyurethane dispersion with a polyester polyol composed of ethylene glycol and adipic acid was synthesized as follows:

The following were charged to a resin kettle and capped with nitrogen: Polyester polyol composed of adipic acid, and ethylene glycol (320 g, 1000 eq.wt., 0.320 eq.), trimethylolpropane (2.46 g, 44.73 eq.wt., 0.550 eq.), Nofia® OL 1001 (29 g, 710.1 eq.wt., 0.0408 eq.), dimethylol propionic acid (25 g, 67.07 eq.wt., 0.3727 eq.), dicyclohexylmethane-4,4′-diisocyanate (149 g, 131.1 eq.wt., 1.1365 eq.), bismuth neodeconate catalyst (0.10 g), methylethylketone (149 g). The mixture was heated to 78 C for 3 hours. The free NCO value was determined by dibutyl amine titration and found to be 2.50% (theory 2.42%). Triethylamine (19.61 g 101.19 eq.wt., 0.1938 eq.) was added and the mixture was stirred for 10 minutes. Water (995 g) was added with rapid mixing to form a water borne polyurethane dispersion. A mixture of N(2-hydroxyethyl)ethylenediamine (18.22 g, 52.075 amine eq.wt., 0.3498 eq.) was mixed with water (49 g) and added to the dispersion slowly. The mixture was stirred for 1 hour then it was vacuum stripped to remove the methylethylketone. A solvent free water borne polyurethane dispersion was produced containing 35% solids. The hydroxyl number of the polyurethane was 18.0.

This OH functional water borne polyurethane dispersion (142.5 g) was compounded with Bayhydur 302 (7.5 g) and K-Stay 730 associative thickener (1.7 g) to give a coating with a viscosity of 60,000 cps. The molar ratio of hydroxyl groups present in the hydroxyl-terminated polyurethane to isocyanate groups of the crosslinker was 0.59. The compounded coating was coated on 200 denier nylon oxford fabric with a knife over roll coater and then heat cured for 90 seconds at 163 degrees C. The coating wt. on fabric is 40.7 g per m² (1.2 ounce per square yard). The vertical flame retardant results were tested:

| Example 3 | Individual char | Individual |
|---|---|---|
| (before | length in cm | after flame |
| leaching) | (inches) | (seconds) |
| Warp | 7.6 (3.0) | 0.0 |
| Warp | 8.9 (3.5) | 0.0 |
| Warp | 11.2 (4.4) | 0.0 |
| Fill | 9.9 (3.9) | 0.0 |
| Fill | 9.1 (3.6) | 0.0 |
| Fill | 8.6 (3.4) | 0.0 |
| Average | 9.1 (3.6) | 0.0 |
| Example 3 | Individual char | |
| (after 72 hours | length in cm | After |
| leacing in water) | (inches) | flame |
| Warp | 8.4 (3.3) | 0.0 |
| Warp | 9.9 (3.9) | 0.0 |
| Warp | 8.9 (3.5) | 0.0 |
| Fill | 9.4 (3.7) | 0.0 |
| Fill | 10.7 (4.2) | 0.0 |
| Fill | 9.7 (3.8) | 0.0 |
| Average | 9.4 (3.7) | 0.0 |

The flame retardant results were excellent with average char lengths of 9.1 cm (3.6 inches) before leaching and 9.4 cm (3.7 inches) after leaching and zero after flames in both cases. These results passed both the CPAI-84 and NFPA 701 tests.

### Example 4 and Comparative Experiments B and C

OH functional water borne polyurethane dispersion containing Nofia® OL 1001 phosphonate diol (Ex 1) resp. Fyrol 6 (Comp B) resp. Exolit OP 550 (Comp C) were prepared and the amounts of the three flame retardant additives were adjusted to keep the weight percent of phosphorous the same in all cases.

The Exolit OP 550 is a non-halogenated phosphorus polyol based on oligomeric organophosphates. It has a hydroxyl number of 170 and an OH equivalent weight of 330 and it contains 17% phosphorous by weight.

Fyrol 6 is diethyl-N,N-bis(2-hydroxyethyl)aminomethyl phosphonate. It has a hydroxyl number of 460 and an OH equivalent weight of 122 and it contains 12.4% phosphorous by weight.

The Nofia® OL 1001 is a copolymer made from bisphenol-A and diphenyl methyl phosphonate. The Nofia® OL1001 has an OH number of 90 and an OH equivalent weight of 623 and it contains 8.5% phosphorous by weight.

Polyurethane dispersions containing these 3 different halogen free, phosphorous based, flame retardants in the backbone of the polymer were made using Desmodur® W (H₁₂MDI), and ethylene glycol adipate polyester polyol and DMPA. The polymers were chain extended with N-(2-hydroxyethyl)ethylene diamine (HEEDA) to make them OH functional. The amounts of the three flame retardant additives were adjusted to keep the weight % phosphorous the same in all three cases. The hydroxyl number of the polyurethanes were respectively 18.0 with the Nofia® OL 1001, 28.8 with the Fyrol 6, and 18.5 with the Exolit OP 550.

Synthesis of a polyurethane dispersion containing Nofia OL 1001: Ethylene glycol adipate polyester polyol (320 g, 1000 eq.wt., 0.320 eq.), trimethylolpropane (2.46 g, 44.73 eq.wt., 0.0550 eq.), dimethylolpropionic acid (25 g, 67.07 eq.wt., 0.3727 eq.), Nofia OL 1001 (29.0 g, 623.3 eq.wt., 0.0465 eq.), Desmodur W (149.0 g, 131.1 eq.wt., 1.1365 eq.) and methylethylketone (150 g) were charged to a resin kettle under nitrogen and mixed and heated to 78 C for 2 hours. The NCO value was determined by dibutyl amine titration and found to be 2.50% (theory 2.42%). Triethylamine 19.61 g, 101.19 eq.wt., 0.1938 eq.) was added and the mixture was stirred for 10 minutes. Water (995 g) was added with rapid mixing and then a mixture of HEEDA (18.22 g, 52.075 amine eq.wt., 0.3499 eq.) and water (49 g) was added slowly. The mixture was stirred for 1 hour and then the methylethylketone was removed by vacuum stripping, leaving a solvent free water borne polyurethane dispersion.

Synthesis of a polyurethane dispersion containing Fyrol FR6: Ethylene glycol adipate polyester polyol (320 g, 1000 eq.wt., 0.320 eq.), trimethylolpropane (2.46 g, 44.73 eq.wt., 0.0550 eq.), dimethylolpropionic acid (25 g, 67.07 eq.wt., 0.3727 eq.), Fyrol FR6 (19.88 g, 121.96 eq.wt., 0.1630 eq.), Desmodur W (185.0 g, 131.1 eq.wt., 1.411 eq.) and methylethylketone (220 g) were charged to a resin kettle under nitrogen and mixed and heated to 78 C for 2 hours. The NCO value was determined by dibutyl amine titration and found to be 2.77% (theory 2.72%). Triethylamine (19.61 g, 101.19 eq.wt., 0.1938 eq.) was added and the mixture was stirred for 10 minutes. Water (1087 g) was added with rapid mixing and then a mixture of HEEDA (31.09 g, 52.075 amine eq.wt., 0.5970 eq.) and water (49 g) was added slowly. The mixture was stirred for 1 hour and then the methylethylketone was removed by vacuum stripping, leaving a solvent free water borne polyurethane dispersion.

Synthesis of a polyurethane dispersion containing Exolit O,P 550: Ethylene glycol adipate polyester polyol (320 g, 1000 eq.wt., 0.320 eq.), trimethylolpropane (2.46 g, 44.73 eq.wt., 0.0550 eq.), dimethylolpropionic acid (25 g, 67.07 eq.wt., 0.3727 eq.), Exolit O,P 550 (14.50 g, 330 eq.wt., 0.0439 eq.), Desmodur W (149.0 g, 131.1 eq.wt., 1.1365 eq.) and methylethylketone (150 g) were charged to a resin kettle under nitrogen and mixed and heated to 78 C for 2 hours. The NCO value was determined by dibutyl amine titration and found to be 2.30% (theory 2.19%). Triethylamine 19.61 g, 101.19 eq.wt., 0.1938 eq.) was added and the mixture was stirred for 10 minutes. Water (972 g) was added with rapid mixing and then a mixture of HEEDA (18.22 g, 52.075 amine eq.wt., 0.3499 eq.) and water (49 g) was added slowly. The mixture was stirred for 1 hour and then the methylethylketone was removed by vacuum stripping, leaving a solvent free water borne polyurethane dispersion.

The water borne polyurethane dispersions were then compounded with Bayhydur 302 isocyanate crosslinker and thickened and coated on 200 denier nylon fabric. The molar ratio of hydroxyl groups present in the hydroxyl-terminated polyurethane to isocyanate groups of the crosslinker was 0.33 in all cases. The coating wt. on fabric is 40.7 g per m² (1.2 ounce per square yard) for Ex 4 and 49.2 g per m² (1.45 ounce per square yard) (Comp C) and 45.8 g per m² (1.35 ounce per square yard) (Comp B). The flame retardant properties were tested using the CPAI-84 test:

| | Resin | Coating | Vertical FR CPAI-84 | | | | |
|---|---|---|---|---|---|---|---|
| | composition | wt. on fabric | | Individual char | | Self | Individual |
| | FR in | g per m² | | length in cm | | Extinguish | after flame |
| | backbone | (oz./yd. 2) | | (inches) | | (seconds) | (seconds) |
| Ex. 4 | Nofia ® | 40.7 (1.2) | Warp | 11.7 | (4.6) | 10.0 | 0.0 |
| | 1001 | | Warp | 9.9 | (3.9) | 7.0 | 0.0 |
| | | | Warp | 8.6 | (3.4) | 6.0 | 0.0 |
| | | | Fill | 9.1 | (3.6) | 4.0 | 0.0 |
| | | | Fill | 11.7 | (4.6) | 2.0 | 0.0 |
| | | | Fill | 11.4 | (4.5) | 7.0 | 0.0 |
| | | | Average | 8.4 | (3.3) | | 0.0 |
| Comp | Fyrol 6 | 49.2 (1.45) | Warp | BEL | | | 90.0 |
| Ex B | | | Warp | 22.4 | (8.8) | | 17.0 |
| | | | Warp | BEL * | | | 120.0 |
| | | | Fill | BEL * | | | 100.0 |
| | | | Fill | 20.8 | (8.2) | | 16.0 |
| | | | Fill | BEL * | | | 90.0 |
| | | | Average | 27.4 | (10.8) | | 72.0 |
| Comp | Exolit | 45.8 (1.35) | Warp | 17.0 | (6.7) | | 8.0 |
| Ex C | OP550 | | Warp | 20.8 | (8.2) | | 90.0 |
| | | | Warp | 19.8 | (7.8) | | 30.0 |
| | | | Fill | 10.4 | (4.1) | | 2.0 |

| Fill | BEL * | | 75.0 |
|---|---|---|---|
| Fill | 17.5 | (6.9) | 50.0 |
| Average | 19.3 | (7.6) | 42.0 |

BEL * = burned entire length

The polymer containing the Nofia® OL 1001 polymer passed the CPAI-84 test and the NFPA-701 flame retardant test with an average char length of 8.4 cm (3.3 inches) and no after flames. The polymer containing Fyrol 6 failed the test with an average char length of 27.4 cm (10.8 inches) and an average after flame of 72 seconds. The polymer containing the Exolit OP 550 also failed the test with an average char length of 19.3 cm (7.6 inches) and an average after flame of 42 seconds. These data show that in these OH functional waterborne polyurethane dispersions the Nofia® OL 1001 has superior flame retardant performance over Exolit OP 550 and Fyrol 6.

The fabric that was coated with the polymer that contained the Nofia® 1001 polymer and crosslinked with Bayhydur 302 (Example 4) was submitted to 3 wash cycles in a washing machine and the flame retardant properties were retested:

| Example 4 | Individual char | Individual |
|---|---|---|
| (after 3 | length in cm | after flame |
| wash cycles) | (inches) | (seconds) |
| Warp | 9.1 (3.6) | 0 |
| Warp | 8.9 (3.5) | 0 |
| Warp | 10.9 (4.3) | 0 |
| Fill | 8.9 (3.5) | 0 |
| Fill | 8.6 (3.4) | 0 |
| Fill | 8.9 (3.5) | 0 |
| Average | 9.1 (3.6) | 0 |

Even after 3 wash cycles, the coated fabric according to the invention passed the CPAI-84 and NFPA-701 flame retardant tests with an average char length of 9.1 cm (3.6 inches) and zero after flames. Thus the flame retardant Nofia® OL 1001 is not washed out of the coating.

The coated fabric of Comparative Experiment B and C were not submitted to washing since these coated fabrics did not even pass the CPAI-84 and NFPA-701 flame retardant tests before the coated fabrics were washed.

### Comparative Experiment D

The polymer containing the Nofia® 1001 polymer (140 g) was thickened with K-stay 730 (1.9 g) to 60,000 cps and coated on 200 denier nylon fabric without an isocyanate crosslinker and then heat cured for 90 seconds at 163° C. The coating weight on the cured fabric was 40.7 g per m² (1.2 oz./square yard). The cured fabric was submitted to 3 wash cycles in a washing machine. The coating was badly delaminated from the fabric. Thus the uncrosslinked coating is not durable to wash cycles.

The flame retardant properties of this coated fabric were tested as described above and the following results were obtained:

| | Individual char | Individual |
|---|---|---|
| | length in cm | after flame |
| | (inches) | (seconds) |
| Warp | 8.1 (3.2) | 0 |
| Warp | 18.3 (7.2) | 15 |
| Warp | 9.9 (3.9) | 0 |
| Fill | 15.7 (6.2) | 6 |
| Fill | 13.7 (5.4) | 30 |
| Fill | 17.8 (7.0) | 22 |
| Average | 14 (5.5) | 12 |

The uncrosslinked coating failed the CPAI-84 and NFPA-701 flame retardant tests with an average after flame value of 12 seconds. This indicates that the uncrosslinked flame retardant coating is not as durable as the isocyanate crosslinked polyurethane coating as for example in Example 1.

1. A flame retardant waterborne coating composition comprising:
a) water dispersed hydroxyl-terminated polyurethane particles, and
b) isocyanate crosslinker,
wherein
(i) the hydroxyl-terminated polyurethane contains phosponate oligomer as a building block in an amount of from 3 to 75 parts by weight relative to the hydroxyl-terminated polyurethane, wherein the phosphonate oligomer contains units according to the following structural formula 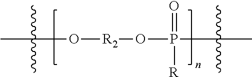
in which n is an integer from 1 to 20, R is a C₁₋₂₀ alkyl, C₂₋₂₀ alkene, C₂₋₂₀ alkyne, C₅₋₂₀ cycloalkyl or C₆₋₂₀ aryl, and R₂ is an aliphatic or aromatic group,
(ii) the hydroxyl number of the hydroxyl-terminated polyurethane is from 5 to 180 mg KOH/g polyurethane,
(iii) the molar ratio of hydroxyl groups present in the hydroxyl-terminated polyurethane to isocyanate groups of the crosslinker is from 0.2 to 2.0.

2. The flame retardant waterborne coating composition according to claim 1, wherein n is from 1 to 10, R₂ is an aromatic group and is preferably derived from bisphenol-A.

3. The flame retardant waterborne composition according to claim 1, wherein R is a methyl group.

4. The flame retardant waterborne coating composition according to claim 1, wherein the phosphonate oligomer used in the preparation of the hydroxyl terminated polyurethane is a phosphonate diol selected from the group consisting of a random co-oligo(phosphonate carbonate), a block co-oligo(phosphonate carbonate), a random co-oligo(phosphonate ester), a block co-oligo(phosphonate ester) or any mixture thereof.

5. The flame retardant waterborne coating composition according to claim 1, wherein the phosphonate oligomer building block has a structure according to one of the following formulae: 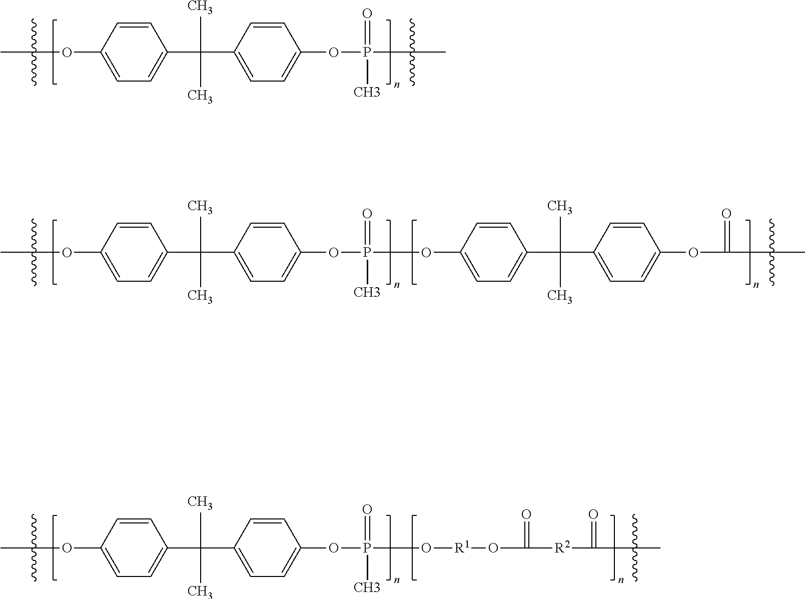
in which R¹ and R² are aliphatic or aromatic hydrocarbons, and n is an integer from 1 to 20, preferably from 1 to 10.

6. The flame retardant waterborne coating composition according to claim 1, wherein the hydroxyl number of the phosphonate oligomer used in the preparation of the hydroxyl terminated polyurethane is from 10 to 200 mg KOH/g phosphonate oligomer, preferably from 40 to 120 mg KOH/g phosphonate oligomer.

7. The flame retardant waterborne coating composition according to claim 1, wherein the OH equivalent weight of the phosphonate oligomer used in the preparation of the hydroxyl terminated polyurethane is from 280 to 5,610, preferably from 450 to 1400.

8. The flame retardant waterborne coating composition according to claim 1, wherein the phosphonate oligomer used in the preparation of the hydroxyl terminated polyurethane is a copolymer of bisphenol-A and diphenyl methyl phosphonate.

9. The flame retardant waterborne coating composition according to claim 1, wherein the amount of hydroxyl-terminated polyurethane is from 10 to 99 wt. %, preferably from 20 to 97 wt. % and more preferably from 25 to 75 wt. % (relative to the total coating composition).

10. The flame retardant waterborne coating composition according to claim 1, wherein the composition is bromine free, preferably halogen free.

11. The flame retardant waterborne coating composition according to claim 1, wherein the hydroxyl-terminated polyurethane is obtained by reacting
(a) from 5 to 50 parts by weight of at least one polyisocyanate,
(b) from 3 to 75 parts by weight of at least one phosphonate diol oligomer as defined in claim 1,
(c) from 0.5 to 30 parts by weight of at least one isocyanate-reactive polyol containing non-ionic, ionic and/or potentially ionic water dispersing groups,
(d) from 0 to 75 parts by weight of at least one isocyanate-reactive polyol not comprised by (b) or (c),
to obtain an isocyanate-terminated polyurethane prepolymer, and reacting the isocyanate-terminated polyurethane prepolymer with
(e) from 0 to 20 parts by weight of neutralizing agent, and
(f) from 1 to 20 parts by weight of at least one active hydrogen-containing chain-extending compound, which is capable of forming hydroxyl groups, whereby the amounts of (a), (b), (c) and (d) are given relative to the total amount of components used to prepare the isocyanate-terminated polyurethane prepolymer from which the building blocks of the isocyanate-terminated polyurethane prepolymer are emanated, and whereby the amounts of (e) and (f) is given relative to the weight amount of the isocyanate-terminated polyurethane prepolymer.

12. The flame retardant waterborne coating composition according to claim 11, wherein the polyol (d) comprises a polyester polyol, a polyether polyol and/or a polycarbonate polyol; preferably the polyol (d) comprises a polyester polyol preferably made from ethylene glycol and adipic acid and/or a polyester polyol made from diethylene glycol and adipic acid.

13. The flame retardant waterborne coating composition according to claim 11, wherein the polyol (c) comprises
(c.1) from 0.5 to 10 wt. %, preferably from 1 to 6 wt. % of an isocyanate-reactive polyol containing ionic and/or potentially ionic water-dispersing groups having a molecular weight of from 100 to 500 g/mol,
(c.2) from 0 to 20 wt. %, preferably from 5 to 15 wt. % of at least one isocyanate-reactive polyol containing non-ionic water-dispersing groups,
where the amounts of (c.1) and (c.2) are given relative to the total amount of components used to prepare the isocyanate-terminate polyurethane prepolymer from which the building blocks of the isocyanate-terminate polyurethane prepolymer are emanated.

14. A coated fabric which is obtained by applying to a textile a coating composition according to claim 1.

15. The coated fabric according to claim 14, wherein the textile containing fibers, preferably polyester fibres, polypropylene fibres, and/or polyamide fibres.

16. An article comprising the coated fabric according to claim 14.

17. The article of claim 16, wherein the article is selected from the group consisting of furniture, a drapery, a garment, linen, a mattress, a carpet, a tent, a sleeping bag, a toy, a decorative fabric, an upholstery, a wall fabric, a curtain, a canopy, clothing apparel, vehicle upholstery, an awning, an airline seat, an airbag cover and combinations thereof.
